(19) United States
(12) Patent Application Publication
(10) Pub. No.: US 2013/0158446 A1
(43) Pub. Date: Jun. 20, 2013

(54) DUAL STIMULATING MASSAGE APPARATUS

(71) Applicant: Simon Siu Man Nan, Ontario (CA)

(72) Inventor: Simon Siu Man Nan, Ontario (CA)

(73) Assignee: Nanma Manufacturing Co., Ltd., Hong Kong (CN)

(21) Appl. No.: 13/328,072

(22) Filed: Dec. 16, 2011

(51) Int. Cl. A61H 1/00; A61H 7/00

(52) U.S. Cl. 601/46; 601/136

(57) ABSTRACT

A dual stimulating massage apparatus including a flexible massage apparatus body including a deformable middle portion having a first end in communication with a ring-shaped portion configured to be engaged to a male sexual organ and a second end in communication with a stimulator portion that defines a receptacle configured to receive a vibratory component therein is disclosed. The deformable middle portion defines a first arm and a second arm that collectively define a deformable opening, wherein when an external force is applied to the stimulator portion the deformable opening assumes a deformed configuration and when the external force is not applied to the stimulator portion the deformable opening assumes a non-deformed configuration such that an individual wearing the massage apparatus may simultaneously provide a massage effect to the wearer of the massage apparatus and the wearer's partner.

### FIELD

The present disclosure is directed to massage apparatuses, and in particular to a dual stimulating massage apparatus configured and adapted to simultaneously apply a massage effect to a male individual wearing the dual stimulating massage apparatus as well as the male individual's female partner during sexual intercourse.

### BACKGROUND

Massage apparatuses for use as marital aid devices are known in the art. Typically, the massage apparatus may include a vibratory component that operates to produce a vibratory or massage effect to an individual wearing the massage apparatus. For example, a massage apparatus may include a ring-shaped portion configured to engage the sexual organ of a male individual so that the individual can experience a massage effect during masturbation or sexual intercourse with a partner. Although massage apparatuses of this type have proven satisfactory for their intended purpose, improvements in such apparatuses are still desired. In particular, it may be desirable to provide a massage apparatus having a dual stimulating vibratory function in which both the male individual wearing the massage apparatus and the male individual's female partner can simultaneously experience a continuous massage effect during sexual intercourse.

### SUMMARY

In one embodiment, a dual stimulating massage apparatus may include a ring-shaped portion defining an opening having a first longitudinal axis and a deformable middle portion defining a first arm and a second arm that collectively form a deformable opening, wherein a first end of the deformable middle portion is in communication with the ring-shaped portion. A stimulator portion includes a receptacle defining a second longitudinal axis in transverse orientation with the first longitudinal axis of the opening for the ring-shaped portion, wherein the stimulator portion is in communication with a second end of the deformable middle portion. In addition, a vibratory component is disposed within the receptacle of the stimulator portion, wherein the deformable middle portion is configured such that when an external force is applied to the stimulator portion the deformable middle portion assumes a deformed state and when the external force is not applied to the stimulator portion the deformable middle portion assumes a non-deformed state.

In another embodiment, method of manufacturing a dual stimulating massage apparatus comprising:
forming a ring-shaped portion defining an opening having a first longitudinal axis;
forming a deformable middle portion in communication with the ring-shaped portion, wherein forming the deformable middle portion includes a first arm and a second arm that collectively define a deformable opening; and
forming a stimulator portion in communication with the deformable middle portion, wherein forming the stimulator portion includes forming a receptacle defining a second longitudinal axis in transverse orientation relative to the first longitudinal axis defined by the opening for the ring-shaped portion.

In yet another embodiment, a method of using a massage apparatus may include:
providing a dual stimulating massage apparatus comprising:
   a ring-shaped portion including an opening defining a first longitudinal axis;
   a deformable middle portion including a first arm and a second arm that collectively form a deformable opening, wherein a first end of the deformable middle portion is in communication with the ring-shaped portion;
   a stimulator portion including a receptacle defining a second longitudinal axis in transverse orientation relative to the first longitudinal axis of the opening for the ring-shaped portion, wherein the stimulator portion is in communication with a second end of the deformable middle portion; and
   a vibratory component disposed within the receptacle of the stimulator portion for providing a vibratory effect;
mounting the ring-shaped portion to a male sexual organ of a male individual; and
applying an external force to the stimulator portion such that the deformable middle portion assumes a deformed state when the external force is applied to the stimulator portion and a non-deformed state when the external force is not applied to the stimulator portion, wherein aligning the stimulator portion along the first axis and second axis when the deformable middle portion assumes the deformed state and non-deformed state, respectively, causes the vibratory effect to be felt simultaneously and continuously by the male individual and the male individual's female partner during sexual intercourse.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a top plan view of a dual stimulating massage apparatus;

FIG. 2 is a bottom plan view of the dual stimulating massage apparatus;

FIG. 3 is a front perspective view of the dual stimulating massage apparatus;

FIG. 4 is a side view of the dual stimulating massage apparatus;

FIG. 5 is an opposing side view of the dual stimulating massage apparatus;

FIG. 6 is an elevated perspective view of the vibratory component configured to be engaged to the dual stimulating massage apparatus;

FIG. 7 is a side view of the vibratory component;

FIG. 8 is a cross-sectional view of the vibratory component taken along line 8-8 of FIG. 7;

FIG. 9 is another cross-sectional view of the vibratory component taken along line 9-9 of FIG. 8;

FIG. 10 is a top view of the vibratory component;

FIG. 11 is an exploded view of the vibratory component;

FIG. 12 is a side view of the dual stimulating massage apparatus attached to a male sexual organ showing the deformation of the massage apparatus (shown in phantom) when a force is applied to the stimulator portion of the massage apparatus body;

FIG. 13 is a flow chart illustrating a method for manufacturing the dual stimulating massage apparatus;

FIG. 14 is a flow chart illustrating a method of using the dual stimulating massage apparatus; and

FIG. 15 illustrates various modes of operation of the vibratory component.

Corresponding reference characters indicate corresponding elements among the view of the drawings. The headings used in the figures should not be interpreted to limit the scope of the claims.

### DETAILED DESCRIPTION

A dual stimulating massage apparatus and method of manufacturing and using such a massage apparatus is described herein that provides a ring-shaped portion configured to be engaged to a male sexual member of a male individual, a stimulator portion configured to have a vibratory component disposed therein for providing a vibratory effect, and a deformable middle portion defined between the ring-shaped portion and the stimulator portion adapted to assume a deformed state in response to an external force being applied to the stimulator portion and a non-deformed state when the external force is removed from the stimulator portion. During the method of use, the dual stimulating massage apparatus is worn by a male individual such that during operation of the massage apparatus both the male individual wearing the massage apparatus and the male individual's female partner simultaneously and continuously feel the vibratory effect imparted by the operation of the massage apparatus during sexual intercourse.

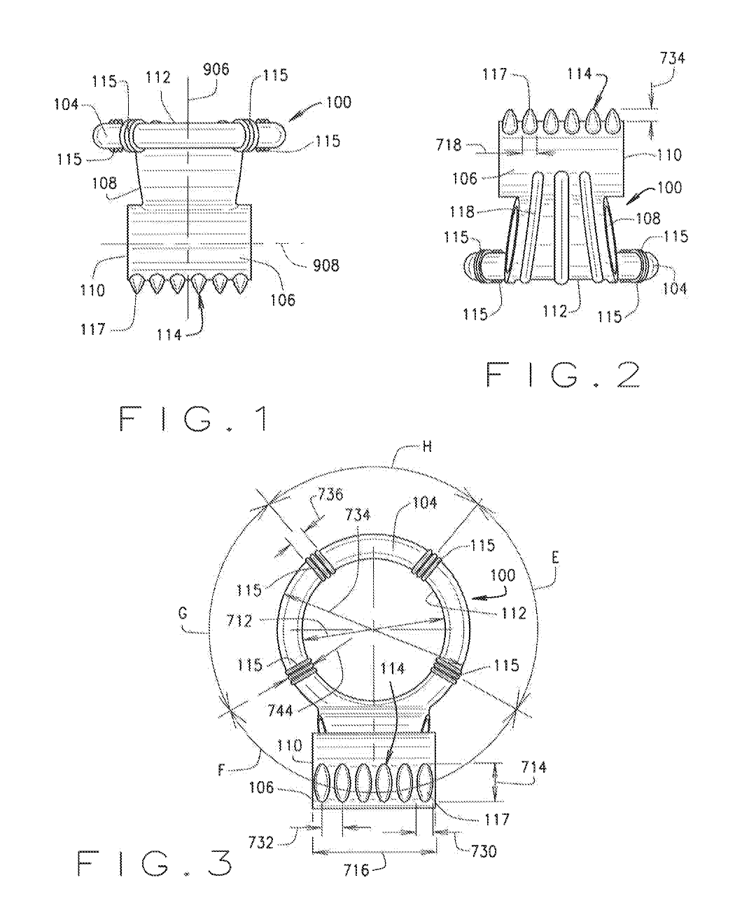

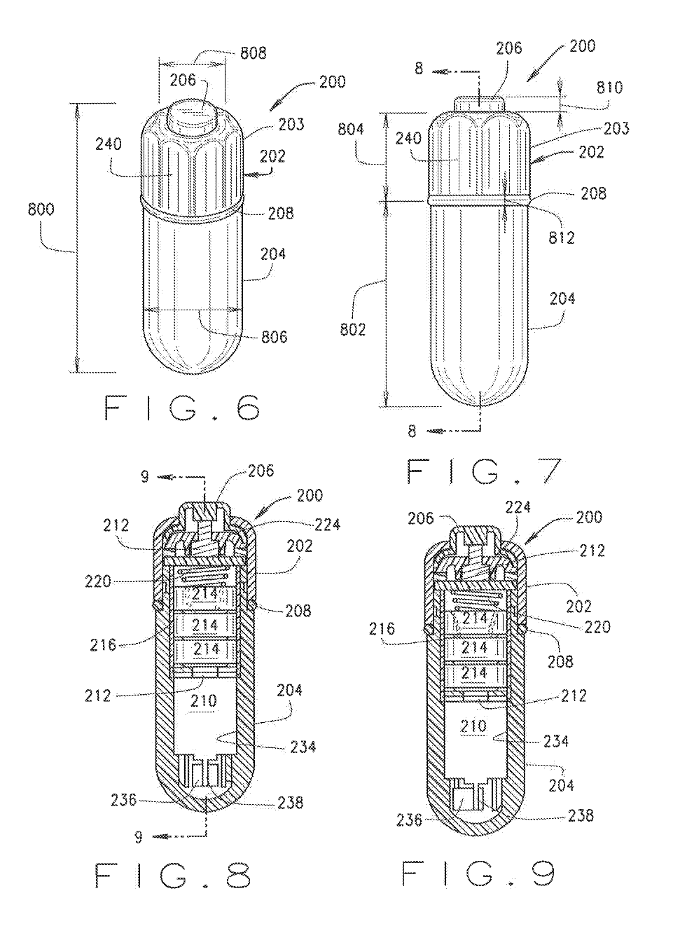

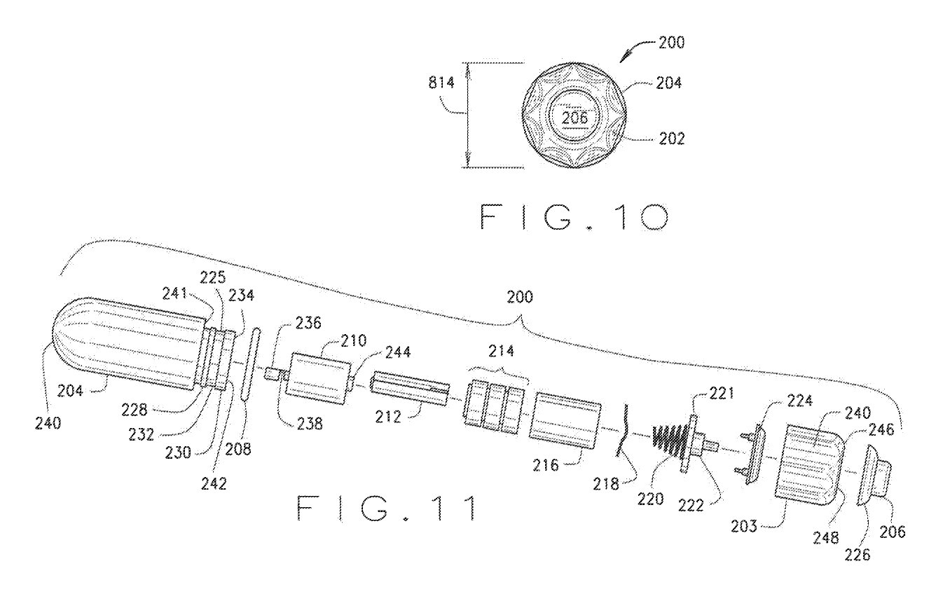

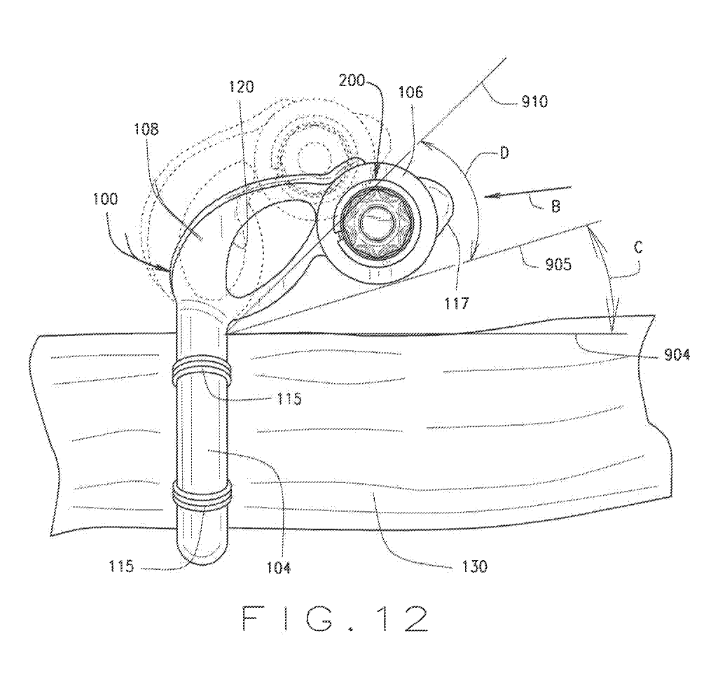

Referring to the drawings, one embodiment of the dual stimulating massage apparatus is illustrated and generally indicated as 100 in FIGS. 1-12. In general, the dual stimulating massage apparatus 100 includes a flexible massage apparatus body 102 having a ring-shaped portion 104, a stimulator portion 106 and a deformable middle portion 108. In particular, the stimulator portion 106 is configured to receive therein a vibratory component 200, which provides a vibratory effect throughout the massage apparatus body 102. Moreover, the ring-shaped portion 104 defines a generally circular-shaped opening 112 configured to engage a male sexual organ 130 such that the dual stimulating massage apparatus 100 is mounted to an individual. In some embodiments, the ring-shaped portion 104 may have a plurality of tubular-shaped members 115, each of the tubular-shaped members 115 having a three-ring arrangement that forms contact points between the wearer and the ring-shaped portion 104. In one aspect, the massage apparatus body 102 may be made from a flexible and deformable material, such as silicon, which permits the ring-shaped portion 104 to expand and fit when engaged to the male individual. The stimulator portion 106 includes a receptacle 110 aligned along a longitudinal axis 906 in transverse orientation relative to longitudinal axis 908 defined through the circular-shaped opening 112 of the ring-shaped portion 104. As shown, the receptacle 110 defines an open-ended channel 111 configured to receive the vibratory component 200 (FIGS. 6-9) therein such that the vibratory component 200 imparts a vibratory effect through the stimulator portion 106, ring-shaped portion 104, and the deformable middle portion 108 when the vibratory component 200 is made operational.

In one embodiment, the stimulator portion 106 includes a clitoral stimulator 114 configured to stimulate the female sexual organ, such as the clitoris of a female partner, when mounted to the male individual during sexual intercourse. In particular, the clitoral stimulator 114 defines a plurality of protrusions 117 formed in a single array across the clitoral stimulator 114 of the stimulator portion 106 for imparting the vibratory or massage effect generated by the vibratory component 200 to particular points of contact along the body of individual's partner. In some embodiments, there are five protrusions 117 in a single array along the clitoral stimulator 114 configured to extend outwardly from the stimulator portion 106. In operation, activating the vibratory component 200 causes the entire flexible massage apparatus body 102 to vibrate, and in particular causes the ring-shaped portion 104, stimulator portion 106, and the deformable middle portion 108 to simultaneously vibrate in a manner that provides a massage effect to both individuals the male individual wearing the dual stimulating massage apparatus 100 and the male individual's female partner—during sexual intercourse. As such, the male individual engaged to the ring-shaped portion 104 experiences the vibratory function imparted by activation of the vibratory component 200 through the ring-shaped portion 104, while the clitoris of the female partner is concurrently stimulated by the vibration of the plurality of protrusions 117 of the clitoral stimulator 114 being in contact with the clitoris of the individual's partner by virtue of the deformable middle portion 108 aligning the stimulator portion 106 at different longitudinal axes related to the in-and-out actions made between the male individual and the female partner during sexual intercourse.

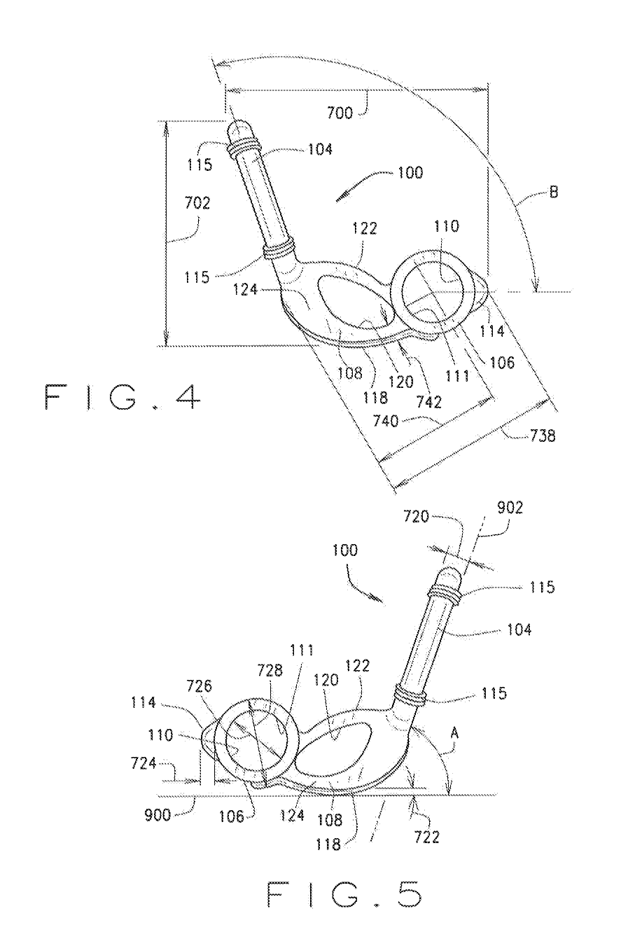

Referring to FIGS. 4 and 5, the deformable middle portion 108 includes a flexible first arm 122 and an opposing flexible second arm 124 that collectively define a deformable opening 120 such that the deformable opening 120 assumes a deformed state from a normally non-deformed state when an external force B (FIG. 12) is applied to the stimulator portion 106 as shall be discussed in greater detail below. Referring to FIG. 12, when the dual stimulating massage apparatus 100 is mounted to a male sexual organ 130, the stimulator portion 106 is aligned along a longitudinal axis 905 when in the non-deformed state (e.g. no external force B is applied) such that the longitudinal axis 905 forms an angle C relative to the longitudinal axis 904 aligned along the male sexual organ 130. However, when the external force B is applied to the stimulator portion 106, such as when contact is made with the individual's partner during sexual intercourse, the deformable middle portion 108 assumes the deformed state (shown in phantom) and causes the stimulator portion 106 to be aligned along longitudinal axis 910 that defines an angle D relative to the longitudinal axis 905. As shown in FIGS. 2, 4 and 5, in some embodiments the deformable middle portion 108 may include a plurality of axial ridges 118 extending along the second arm 124 of the deformable middle portion 108 in parallel orientation relative to longitudinal axis 906.

Referring to FIGS. 6-11, in some embodiments the vibratory component 200 may include a vibrator body 202 having an upper body 203 engaged to a lower body 204 with a sealing element 208, such as an O-ring made from a silicon material, interposed between the upper body 203 and lower body 204 to establish a water-proof seal to the vibratory body 202. In some embodiments, the upper body 203 and the lower body 204 may be made from an Acrylonitrile Butadiene Styrene (ABS) material. As illustrated, the lower body 204 includes a proximal end 240 defining a substantially semi-hemispherical shaped end and a distal end 241 having an axial extension 225 that extends outwardly from the lower body 204. As shown, the axial extension 225 has a generally tubular shaped body having a first flange 228 and a second flange 230 formed around the circumference of the axial extension 225. The first and second flanges 228 and 230 collectively form a circumferential channel 232 configured to engage interior engagement elements of the upper body 203 when securing the lower body 203 to the upper body 204. In addition, an opening 242 is formed adjacent the second flange 230 in communication with an interior cavity 234 formed inside the lower body 204, and configured to encase the various components of the vibratory component 200 inside the vibrator body 202 as shall be discussed in greater detail below. As further shown, the upper body 203 defines a plurality of axially aligned flat surfaces 240 formed around the circumference of the upper body 203, which are configured to be used as a grasping surface by the user, for example by an individual's fingers in a twisting motion to engage and disengage the upper body 203 relative to the lower body 204 when assembling and disassembling the vibrator body 202.

In some embodiments, the vibratory component 200 may include a vibratory motor 210 having a rotating shaft 238 engaged to an eccentric mass 236 that produces a vibratory effect when the rotating shaft 238 spins the eccentric mass 236 after the vibratory motor 210 is made operational. The vibratory motor 210 includes an electrical contact 244 configured to engage a polarity component 212 adapted to permit electrical current from a power source, such as a plurality of batteries 214, to energize the vibratory motor 210 through the electrical contact 244. However, the vibratory component 200 is not limited to the embodiment of the vibratory motor 210 having the rotating shaft 238 and eccentric mass 236 arrangement and that other types of vibratory components may be used to produce the vibratory effect for the vibratory component 200.

As further shown in FIG. 11, the vibratory component 200 includes a PVC insulator 216 configured to encase the plurality of batteries 214 and provide an electric insulation layer between the batteries 214 and metallic portions of the vibratory component 200 to prevent a short circuit of the vibratory component 200. A contact plate 218 is interposed between the batteries 214 and a metallic spring 220, which is engaged to a printed circuit board 221 for controlling the operation of the vibratory motor 210. In some embodiments, a control switch 222 is operatively engaged to the printed circuit board 221 for controlling the operation of the vibratory motor 210. For example, initially engaging the control switch 222 activates the vibratory motor 210 at a particular mode of operation, while subsequent engagements of the control switch 222 may cause the printed circuit board 221 to operate the vibratory motor 210 in different modes of operation as shall be discussed in greater detail below. A fixture 224 is engaged to the printed circuit board 221 for mounting the printed circuit board 221 within the upper body 204 of the vibratory component 200. As further shown, the control switch 222 is operatively engaged to an activation button 206 mounted within a base 226 that is engaged to a distal end 246 of the upper body 203. Depression or actuation of the activation button 206 concurrently actuates the control switch 222. The distal end 246 of the upper body 203 defines an opening 248 configured to engage the base 226.

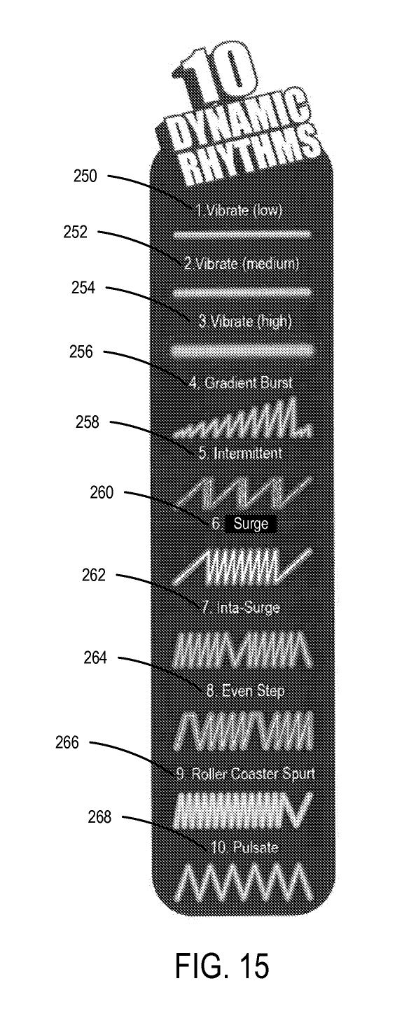

Referring to FIG. 15, the operation of the printed circuit board 221 and the various modes of operating the vibratory motor 210 will be discussed. In some embodiments, initial activation of the control switch 222 by actuation of the activation button 206 causes the vibratory motor 210 to be made operational in a low vibrate mode 250 in which the vibratory motor 210 produces low, constant vibrations. Subsequent activation of the control switch 222 causes the vibratory motor 210 to sequentially assume various other modes of vibratory operation. For example, actuation of the control switch 222 causes the vibratory motor 210 to operate in a medium vibrate mode 252 that imparts a greater degree of constant vibration than when the vibratory motor 210 is in the low vibrate mode 250. In addition, the printed circuit board 221 may operate the vibratory motor 210 in the following modes of vibration: a high vibrate mode 254 that imparts the greatest degree of constant vibration relative to the low and medium vibrate modes 250 and 252, a gradient burst vibrate mode 256 that gradually builds from a low level of vibration to a higher level of vibration over a predetermined time period, an intermittent vibrate mode 258 that vibrates between lower and greater modes of vibration, a surge vibrate mode 260 that surges between a slow rate of vibration to a fast rate of vibration, a inta-surge vibrate mode 262 that surges between slow and fast rates of vibration with a brief non-surge of vibration between surges, an even-step vibrate mode 264 that maintains a high rate of vibration for a predetermined period at select time intervals, a roller coaster spurt vibrate mode 266 that vibrates at a high rate of vibration with an interval of lower frequency between vibrations at periodic predetermined periods of time, and a pulsate vibrate mode 268 that vibrates in a pulsating manner with a predetermined rate of frequency. Although the modes of vibration discussed above are activated in sequential order as illustrated in FIG. 15, other sequences for activating these modes of vibration are contemplated.

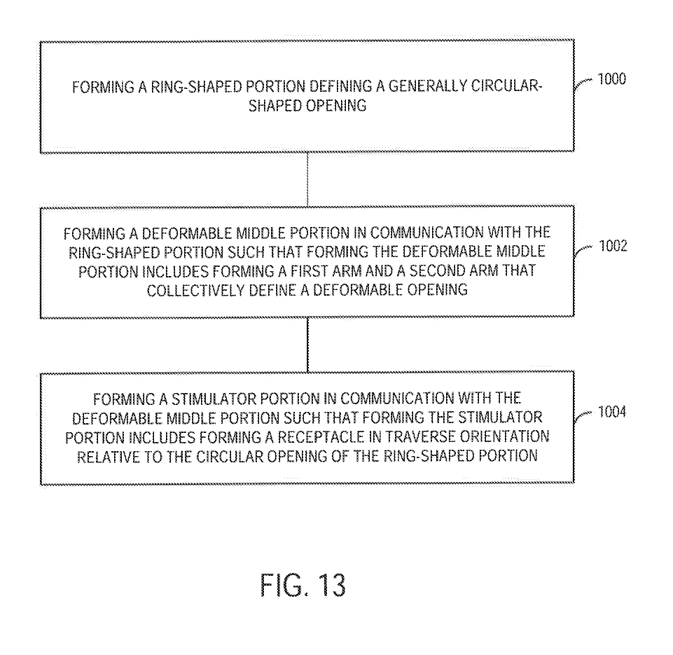

Referring to FIG. 13, a flow chart is shown illustrating one method for manufacturing the dual stimulating massage apparatus 100. At block 1000, forming a ring-shaped portion 104 defining a generally circular-shaped opening 112. At block 1002, forming a deformable middle portion 108 in communication with the ring-shaped portion 104, wherein the deformable middle portion 108 defines a first arm 122 and a second arm 124 that collectively form a deformable opening 120. At block 1004, forming a stimulator portion 106 in communication with the deformable middle portion 108, wherein the stimulator portion 106 defines a receptacle 110 forming an open-ended channel 111 defining a longitudinal axis in transverse orientation relative to the longitudinal axis circular opening 112 of the ring-shaped portion 104. At block 1006, disposing a vibratory component 200 within the receptacle 110.

In some embodiments, the manufacture of the dual stimulating massage apparatus 100 may utilize the following dimensions. As shown in FIG. 4, the massage apparatus body 102 may have a length 700 of about 49.00 mm and a height 702 of about 71.52 mm. As shown in FIGS. 3 and 5, the circular opening 112 of the ring-shaped portion 104 may have an inner diameter 712 of 36.00 mm and an outer diameter 734 of about 50.00 mm, while the ring-shaped portion 104 may have a width 720 of about 7.00 mm. In addition, each of the plurality of raised protrusions 118 may have a length 714 of about 9.60 mm, a width 730 of about 3.93 mm, a height 734 (FIG. 2) of about 3.00 mm, and a spacing 732 between any two adjacent protrusions 118 of about 5.45 mm as illustrated in FIG. 3. As shown in FIG. 4, the deformable middle portion 108 and the stimulator portion 106 may collectively have a length 738 of about 49.00 mm, while a length 704 as defined from the middle of the receptacle 110 to the end of the deformable middle portion 108 adjacent the ring-shaped portion 104 is about 31.53 mm. Referring back to FIG. 5, the receptacle 110 of the stimulator portion 106 may have an inner diameter 726 of about 17.00 mm and an outer diameter 728 of about 18.90 mm, while each of the raised ridges 118 may have a height 722 of about 1.20 mm. As illustrated, each of the protrusions 114 may have a height 724 of about 3.00 mm. As shown in FIG. 5, when a portion of the deformable middle portion 108 lies along a first plane 900, the ring-shaped portion 104 will lie along a second plane 902 such that an angle A is defined between the first plane 900 and the second plane 902 of about 72 degrees. Referring to FIG. 4, in one configuration of the massage apparatus body 102 the ring-shaped portion 104 may be aligned along a plane 904, while the stimulator portion 106 may be aligned along a plane 906 that forms an angle B of about 108 degrees. Referring back to FIG. 3, each of the tubular-shaped portions 115 may have a width 736 of about 4.50 mm and a length 744 of about 8.50 mm, while the spacing between the tubular-shaped portions 115 may be equidistant and define angles E, F, G and H of about 80 degrees.

In some embodiments, the manufacture of the vibratory component 200 may utilize the following dimensions in the construction of the vibrator body 202. As shown in FIGS. 6-10, the vibrator body 202 may have a height 800 of about 59.70 mm, while the lower body 204 of the vibrator body 202 may have a width 806 of about 18.50 mm. In addition, the upper body 203 may have a height 804 of about 18.00 mm, while the lower body 204 may have a height 802 of about 38.95 mm. As further shown, the sealing element 208 may have a thickness 812 of about 2.20 mm, while the activation button 206 may have a width 808 of about 9.20 mm and a height 810 of about 2.75 mm. Referring to FIG. 10, the upper body 203 may have a width 814 of about 19.17 mm. Although the above dimensions may be used for manufacturing the vibratory component 200, other dimensions for manufacturing the vibratory body 202 may be used as long as the dimensions permit the vibratory component 200 to be engaged and disposed within the receptacle stimulator portion 106.

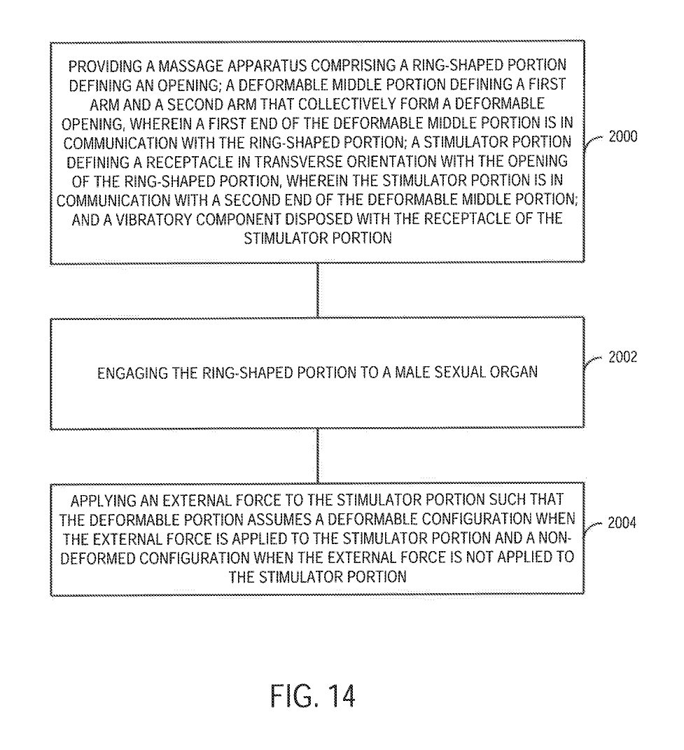

Referring to FIG. 14, a flow chart is shown illustrating one method of using the dual stimulating massage apparatus. At block 2000, providing a dual stimulating massage apparatus 100 including a ring-shaped portion 104 defining an opening 112; a deformable middle portion 108 defining a first arm 122 and a second arm 124 that collectively form a deformable opening 120, wherein the deformable middle portion 108 is in communication with the ring-shaped portion 104; a stimulator portion 106 defines a receptacle 110 defining a longitudinal axis in transverse orientation relative to a second longitudinal axis defined by the opening 112 of the ring-shaped portion 104, wherein the stimulator portion 106 is in communication with a second end of the deformable middle portion 108; and a vibratory component 200 is disposed within the receptacle 112 of the stimulator portion 106. At block 2002, engaging the ring-shaped portion to the male sexual organ 130. At block 2004, applying an external force B to the stimulator portion 106, for example by contact with the male individuals female partner during sexual intercourse, such that the deformable opening 120 assumes a deformed configuration when the external force B is applied to the stimulator portion 106 and a non-deformed configuration when the external force B is not applied to the stimulator portion 106 as illustrated in FIG. 12.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A massage apparatus comprising:
a ring-shaped portion defining an opening having a first longitudinal axis;
a deformable middle portion defining a first arm and a second arm that collectively form a deformable opening, wherein a first end of the deformable middle portion is in communication with the ring-shaped portion;
a stimulator portion includes a receptacle defining a second longitudinal axis in transverse orientation with the first longitudinal axis defined by the opening for the ring-shaped portion, wherein the stimulator portion is in communication with a second end of the deformable middle portion; and
a vibratory component disposed within the receptacle of the stimulator portion; wherein the deformable middle portion is configured such that when an external force is applied to the stimulator portion the deformable middle portion assumes a deformed state and when the external force is not applied to the stimulator portion the deformable middle portion assumes a non-deformed state.

2. The massage apparatus of claim 1, further comprising:
a plurality of protrusions defined along the stimulator portion for providing a massage effect when the vibratory component is operational.

3. The massage apparatus of claim 1, further comprising:
a plurality of raised ridges defined along the deformable middle portion.

4. The massage apparatus of claim 1, wherein the stimulator portion is aligned along a first axis when the deformable middle portion is in the non-deformed state and wherein the stimulator portion is aligned along a second axis when the deformable middle portion is in the non-deformed state.

5. The massage apparatus of claim 4, wherein when the deformable middle portion is in the deformed state the second axis of the stimulator portion is positioned above the first axis of the stimulator portion when the deformable middle portion is in the non-deformed state.

6. The massage apparatus of claim 5, wherein the first axis of the stimulator portion when the deformable middle portion is the non-deformed state forms an angle with the second axis of the stimulator portion of between 30 degrees to 45 degrees when the deformable middle portion is in the deformed state.

7. The massage apparatus of claim 1, wherein the ring-shaped portion is aligned along a third plane, wherein the third plane forms an acute angle relative to the first plane.

8. The massage apparatus of claim 2, wherein the plurality of protrusions is arranged in at least one array.

9. The massage apparatus of claim 1, wherein the vibratory component includes a middle portion formed between a first spherical end and a second spherical end.

10. The massage apparatus of claim 9, wherein first spherical end and the second spherical end each define a plurality of raised protrusions.

11. The massage apparatus of claim 9, wherein the vibratory component includes a first flange defined between the middle portion and the first spherical end and a second flange defined between the middle portion and the second spherical end.

12. The massage apparatus of claim 11, wherein a first channel is defined between the middle portion and the first flange and a second channel is defined between the middle portion and the second flange.

13. The massage apparatus of claim 1, wherein the first flange and second flange are configured to engage the vibratory component within the receptacle of the stimulator portion.

14. The massage apparatus of claim 13, wherein the first spherical end and the second spherical end extend outwardly from the receptacle when the vibratory component is disposed within the receptacle.

15. A method of manufacturing a massage apparatus comprising:
forming a ring-shaped portion defining an opening having a first longitudinal axis;
forming a deformable middle portion in communication with the ring-shaped portion, wherein forming the deformable middle portion includes a first arm and a second arm that collectively define a deformable opening; and
forming a stimulator portion in communication with the deformable middle portion, wherein forming the stimulator portion includes forming a receptacle defining a first longitudinal axis in transverse orientation relative to a second longitudinal axis defined by the opening for the ring-shaped portion.

16. The method of claim 15, further comprising:
disposing a vibratory component within the receptacle.

17. The method of claim 15, wherein the deformable opening of the deformable middle portion is configured to assume a deformed state when an external force is applied to the stimulator portion and a non-deformed state when the external force is not applied to the stimulator portion.

18. The method of claim 15, wherein the massage apparatus is formed from at least a silicone material.

19. A method of using a massage apparatus comprising:
providing a massage apparatus comprising:
a ring-shaped portion including an opening defining a first longitudinal axis;
a deformable middle portion including a first arm and a second arm that collectively form a deformable opening, wherein a first end of the deformable middle portion is in communication with the ring-shaped portion;
a stimulator portion defining a receptacle having a second longitudinal axis in transverse orientation relative to the first longitudinal axis of the opening for the ring-shaped portion, wherein the stimulator portion is in communication with a second end of the deformable middle portion; and
a vibratory component disposed within the receptacle of the stimulator portion for providing a vibratory effect;
mounting the ring-shaped portion to a male sexual organ of a male individual; and
applying an external force to the stimulator portion such that the deformable middle portion assumes a deformed state when the external force is applied to the stimulator portion and a non-deformed state when the external force is not applied to the stimulator portion.

20. The method of claim 19, wherein applying an external force to the stimulator portion aligns the stimulator portion along a second axis when the deformable middle portion assumes a deformed state and removing the external force to the stimulator portion aligns the stimulator portion along a first axis when the deformable middle portion assumes a non-deformed state.

21. The method of claim 20, wherein aligning the stimulator portion along the first axis and second axis when the deformable middle portion assumes the deformed state and non-deformed state, respectively, causes the vibratory effect to be felt simultaneously and continuously by the male individual and the male individual's female partner during sexual intercourse.
